(19) United States
(12) Patent Application Publication
(10) Pub. No.: US 2020/0360999 A1
(43) Pub. Date: Nov. 19, 2020

(54) METHOD FOR MANUFACTURING A MAGNETIZED ROTATING COMPONENT, ROTATING COMPONENT AND SYSTEM FOR MEASURING ROTATION OF A ROTATING COMPONENT

(71) Applicant: SAFRAN TRANSMISSION SYSTEMS, Colombes (FR)

(72) Inventor: Florian RAPPAPORT, Moissy Cramayel (FR)

(21) Appl. No.: 16/762,822

(22) PCT Filed: Nov. 5, 2018
(86) PCT No.: PCT/FR2018/052716

§ 371 Date: May 8, 2020

(30) Foreign Application Priority Data
Nov. 10, 2017 (FR) 1760603

(51) Int. Cl. B22F 5/08; B33Y 10/00; B33Y 80/00; B33Y 70/00; B22F 3/105; G01P 3/481; B23K 26/342; H01F 1/055; H01F 41/02

(52) U.S. Cl. CPC B22F 5/08; B33Y 10/00; B33Y 80/00; B33Y 70/00; H01F 41/0253; G01P 3/481; B23K 26/342; H01F 1/055; B22F 3/1055

(57) ABSTRACT

The invention relates to a method for manufacturing a component able to rotate about an axis, comprising a step of incorporating a magnetic material into the powder during the manufacture of the rotating component, in at least one predefined zone of the component formed. The invention also relates to a rotating component obtained using this method and to a system for measuring rotation of the rotating component obtained by this method, by using at least one sensor able to detect the passage of the zone into which the magnetic material is incorporated.

### 1. TECHNICAL FIELD OF THE INVENTION

The invention relates to a method for manufacturing a rotating component, in particular so as to obtain a rotating component whose speed of rotation can be measured by a suitable measuring system. The method and system are particularly adapted to the industrial field of aircrafts, more generally vehicles, and to rotating components subject to significant stresses, in particular rotating components of gearboxes which are in an environment which can be subjected to oil mist, a wide temperature range (in particular between −54° C. and 200° C.), and vibrations.

### 2. BACKGROUND

The prior art includes in particular documents WO-A1-2015/062592 and FR-A1-3 049 385.

The systems for measuring the speed of rotation of the rotating components are available in various alternatives.

A first well-known alternative is a measuring system for measuring speed of rotation with a phonic wheel consisting of toothing and fitted to the rotating component. A proximity sensor, arranged opposite the phonic wheel, allows to detect the passage of each of the teeth of the toothing of the phonic wheel, thus enabling the rotational speed of the rotating component to be determined with fine resolution. However, this type of measuring system requires the use of a specific toothing (if the component does not already have one that can be used) adding mass to the component. This type of measuring system is described, for example, in the French patent applications FR2633722, FR2891361 and FR2896882.

Another alternative is a measuring system for measuring speed of rotation with a rotary encoder, where a sensor (inductive, capacitive, optical or magnetic) is used to read a tape or hole disc forming an encoder system. A processing unit then converts the encoding into a signal representative of the rotation. However, this type of measuring system is expensive to implement, at a low frequency amplitude and when an optical sensor is used, is not compatible with an oil mist type environment.

A last alternative has been studied but still raises several problems: adding a magnet-type add-on component to a rotating component combined with a sensor allowing to detect the passage of the component in front of the sensor. However, adding a component causes several problems, such as the formation of an unbalance on the rotating component and the need to have a solid fixation between the rotating component and the add-on component in order to resist the centrifugal force due to the rotation of the rotating component.

### 3. OBJECTIVES OF THE INVENTION

The invention is intended to overcome at least some of the disadvantages of well-known systems for measuring speed of rotation of rotating components.

In particular, the invention aims at providing, in at least one embodiment of the invention, a method for manufacturing a rotating component, the rotating component thus manufactured being particularly adapted so that its speed of rotation is measured by a measuring system.

The invention also aims to provide, in at least one embodiment, a method for manufacturing a rotating component making it possible to obtain a rotating component whose speed of rotation can be measured without significant addition of mass or of an add-on component causing potential fixing problems.

The invention also aims to provide, in at least one embodiment of the invention, a method for manufacturing a rotating component making it possible to obtain a rotating component whose speed of rotation can be measured without causing an unbalance on the rotating component.

The invention also aims to provide, in at least one embodiment of the invention, a method for manufacturing a rotating component making it possible to obtain a rotating component whose speed of rotation can be measured at high temperatures and/or in a vibration environment.

The invention also aims to provide, in at least one embodiment of the invention, a method for manufacturing a rotating component making it possible to obtain a rotating component whose speed of rotation can be measured in the presence of oil mist or of another atmosphere which does not allow satisfactory optical reading.

The invention also aims to provide, in at least one embodiment, a rotating component whose speed of rotation can be easily measured at low cost.

The invention also aims to provide, in at least one embodiment, a measuring system for measuring the speed of rotation of a rotating component at low cost, accurate and adding little mass.

### 4. SUMMARY OF THE INVENTION

For this purpose, the invention relates to a method for manufacturing a rotating component, rotating about an axis, comprising:
a step of producing a formed component from a material in powder form,
a step of obtaining the rotating component from the formed component characterised in that the method comprises a step of incorporating a magnetic material into the powder during the production of the formed component, in a predefined zone of the formed component, called the magnetized zone, the magnetic material having the following characteristics:
a magnetic remanence (Br) greater than or equal to 0.1 T;
a Curie temperature (T_{c}) greater than or equal to 250° C.;
a hardness of between 75% and 125% of the hardness of the material of the formed component and a density of between 80% and 120% of the density of the material of the formed component.

A method according to the invention thus makes it possible to obtain a component in rotation having a magnetized zone in which a magnetic material is present, without the addition of an add-on component because the magnetized zone is directly produced by incorporating magnetic material during the production of the component itself from the powder. By choosing a material of ideally identical hardness and density and at least close to the material of the formed component, the magnetized zone thus introduces no significant unbalance into the rotating component, and the hardness in the zone is significantly homogeneous in and around the magnetized zone. The hardness is preferably expressed in Vickers hardness, or in other types of hardness depending on the measuring mode. The magnetized zone forms a local magnetization of the rotating component. Furthermore, there is no risk of the magnetized zone becoming detached due to centrifugal force when the component is rotating.

Preferably with d the hardness of the magnetic material, x the density of the magnetic material, D the hardness of the formed component and X the density of the formed component, d=D±((kD/100), with k=25 or 20 or 15 or 10 or 5, the lowest being the best, and x=X±((nX)/100), with n=20 or 15 or 10 or 5, the lowest being the best.

In addition, the magnetic remanence (commonly identified by the term Br in the literature) greater than or equal to 0.1 T results in a high magnetic power which makes it possible to ensure detection of the disturbance of the magnetic field caused by the magnetized zone when using the rotating component with a measuring system for measuring the speed of rotation of the rotating component.

Finally, the Curie temperature (commonly identified by the term T_{c} in the literature) greater than or equal to 250° C. ensures that the magnetized zone maintains sufficient magnetization in the temperature range to which the component in rotation is subjected, for example typically [−54° C.; 200° C.] in a gearbox. The temperature rise does not lead to demagnetisation. Preferably, the temperature coefficient of the remanence should be low (less than or equal to 1%/° C.) in order to limit the variations of the magnetic remanence in the event of temperature variations.

In addition, the magnetized zone is a predetermined zone, for example by calculation, so that the presence of the magnetic material has a minimum impact on the mechanical stresses in operation of the rotating component.

The material for manufacturing the formed component is, for example, a metal or a metal alloy, e.g. a steel alloy (e.g. 16NCD13, 32CDV13, or 40CDV12).

The formed component is the result of the processing of the powder, and the formed component is then further processed if necessary to obtain the rotating component. Advantageously and according to the invention, the step of obtaining the rotating component comprises a step of machining the formed component and/or a step of assembling it with another component so as to form the rotating component.

A rotating component is also called a component in rotation, and designates a component whose main function requires it to be rotated, in particular to transmit a torque or a movement. The rotating component is for example a shaft (in particular, a transmission shaft), a pinion, etc.

Advantageously and according to the invention, the magnetic material is a samarium-cobalt, Neodymium, or AINiCo alloy.

According to this aspect of the invention, the samarium-cobalt alloy, Neodymium, or AlNiCo, frequently used in the manufacture of magnets and having the features stated above.

Advantageously and according to the invention, the magnetic material is incorporated in particles or a pellet form.

According to this aspect of the invention, the particle or pellet form allows for easy incorporation of the magnetic material into the powder during the manufacture of the formed component. The particles are mixed with the powder forming the material and making it heterogeneous, while the pellet is a small component of variable size and shape forming a homogeneous whole, integrated into the formed component during its manufacture.

Advantageously and according to the invention, the magnetized zone is a zone of the component corresponding to an eccentric zone of the axis of the rotating component.

According to this aspect of the invention, during the rotation of the rotating component, the magnetized zone rotates around the axis as a result of the rotation of the rotating component. It is thus possible to detect the passage of the magnetized zone in front of a sensor receptive to magnetic changes, as explained below.

Advantageously and according to the invention, the step of producing the rotating component from the powder and the integration of the magnetic material are carried out by additive manufacturing, preferably by sintering or laser melting.

According to this aspect of the invention, the additive manufacturing is, in particular sintering or laser melting, particularly suitable for manufacturing objects from powder, and allows the easy incorporation of the magnetic material when producing the formed component.

The invention also relates to a rotating component obtained by a method according to the invention, characterized in that it comprises an integrated magnetized zone.

A rotating component according to the invention therefore has no unbalance and is suitable for use in an environment such as that of a gearbox. In addition, it is possible to easily measure its speed of rotation.

Advantageously and according to the invention, the magnetic zone is eccentric to the axis of the rotating component.

According to this aspect of the invention, the magnetic zone describes a circular movement during the rotation of the rotating component, and the time between two passages of the magnetic zone in front of a sensor is representative of the rotational speed of the rotating component.

The invention also relates to a measuring system for measuring the speed of rotation of a rotating component according to the invention, characterized in that it comprises a plurality of sensors arranged in the proximity of the zone of the rotating component comprising the magnetic material and configured so as to each detect a passage of the magnetic zone in front of each sensor in different angular sectors during the rotation of the rotating component.

A measuring system according to the invention allows the measurement of the speed of a rotating component obtained by the method according to the invention, thanks to the presence of at least one sensor arranged in such a way that it detects the passages of the magnetized zone in its proximity, by variation of the magnetic field. The sensor is for example an active sensor (Hall effect or magnetoresistance type), or a passive sensor (eddy current type). The sensor is for example a fixed sensor, or a mobile sensor whose position is known at any time with respect to the position of the magnetized sector of the rotating component.

The measurement of the speed of rotation is thus obtained without contact, and can be carried out in an environment comprising an oil mist, a wide operating temperature range (in particular [−54° C.; 200° C.] in a gearbox), and a vibration environment.

In order to increase the resolution of the measuring system, it is possible to use several sensors each detecting a passage of the magnetized zone in a different angular sector, and/or to magnetize several angular sectors of the rotating component, and/or to use one or more mobile sensors.

Advantageously and according to the invention, at least one sensor is arranged in a hollow web of the rotating component.

According to this aspect of the invention, the space requirement of the measuring system is reduced because at least one sensor (preferably all sensors) is arranged inside the rotating component. For example, the sensor can be arranged on the axis of rotation of the rotating component.

Advantageously, a measuring system according to the invention comprises a plurality of sensors configured so as to each detect a passage of a plurality of magnetic zones in different angular sectors.

According to this aspect of the invention, the plurality of sensors and the plurality of magnetic zones make it possible to increase the resolution of the measuring system.

Advantageously, a measuring system according to the invention comprises at least one mobile sensor, the position of which is known at any time with respect to the zone of the rotating component comprising the magnetic material, arranged in the proximity of the magnetic zone, the system being configured so as to detect a passage of the magnetic zone in front of each sensor during rotation of the rotating component.

According to this aspect of the invention, the mobile sensor can itself be rotated, in particular in the opposite direction to the rotating component, and thus further detect the magnetized zone, thereby increasing the resolution of the measuring system without adding a sensor or magnetized zone.

The invention also relates to a method, a rotating component and a measuring system characterized in combination by some or all of the above or following features.

### 5. LIST OF FIGURES

Other purposes, features and advantages of the invention will appear when reading the following description, which is given only in a non-exhaustive manner and refers to the annexed figures in which :

FIG. 1 is a schematic view of a method for manufacturing a rotating component according to an embodiment of the invention,

FIG. 2 is a schematic partial perspective view of a rotating component according to an embodiment of the invention, obtained by the manufacturing method,

FIG. 3 is a schematic sectional and perspective view of a rotating component and a measuring system for measuring the speed of rotation of the rotating component, according to an embodiment of the invention.

### 6. DETAILED DESCRIPTION OF AN EMBODIMENT OF THE INVENTION

The following embodiments are examples. Although the description refers to one or more embodiments, this does not necessarily mean that each reference relates to the same embodiment, or that the features apply only to one embodiment. Simple features of different embodiments can also be combined to provide other embodiments. In the figures, scales and proportions are not strictly adhered to for the sake of illustration and clarity.

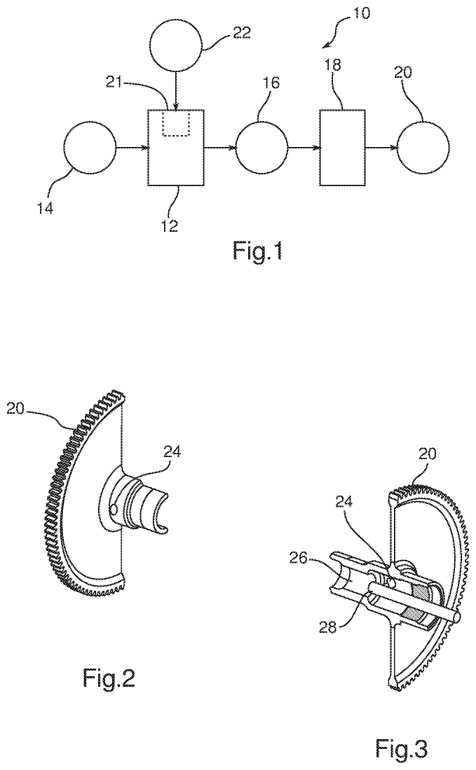

FIG. 1 schematically represents a method 10 for manufacturing a rotating component according to an embodiment of the invention. The circles represent the products and the rectangles represent steps allowing the passage from one product to another.

A first step represented is a step 12 of producing a formed component 16 from a material in powder form 14. This production step, known from prior art, is preferably carried out by additive manufacturing, for example by sintering or laser melting.

A second step represented is a step 18 of obtaining a rotating component 20 from the formed component 16. This step includes, for example, a machining step of the formed component 16, but may also include other known processing steps in the manufacturing of industrial component.

The particularity of the method according to the invention is that it comprises a step 21 of incorporating a magnetic material 22, for example in a particles or pellet form, into the powder during the step of producing the formed component 16, in a predefined zone (for example by calculation) of the formed component 16, known as the magnetized zone. Contrary to the techniques of the prior art where a magnetic component was added to the rotating component, the invention allows the incorporation directly during the production of the component.

FIG. 2 shows schematically and partially in perspective a rotating component 20 according to an embodiment of the invention, obtained by the method for manufacturing as described above. The rotating component 20, here a pinion, thus comprises a magnetized zone 24, here visible on an external face of the pinion.

FIG. 3 schematically shows a schematic cross-section and perspective representation of a rotating component and a measuring system for measuring the speed of rotation of the rotating component, according to an embodiment of the invention. The rotating component 20 comprises here a magnetized zone 24 arranged inside a hollow web 26 of the rotating component 20. In the centre of the hollow web 26, a sensor 28 of the measuring system is arranged in the region of the axis of rotation of the rotating component 20. The sensor 28 is arranged in such a way that a passage of the magnetized zone 24 in front of it can be detected, so that the speed of rotation of the rotating component 20 can be easily determined as a function of the time elapsed between each passage of the magnetized zone 24. In order to improve the resolution of the measurement, it is possible to use several sensors each detecting the passage of the magnetized zone 24 in a different angular sector. The arrangement of the sensor in the hollow web 26 of the rotating component reduces the space requirement of the measuring system.

The sensor is a sensor that can detect a change in the surrounding magnetic field, in particular that caused by the magnetized zone. The sensor is for example an active sensor of the Hall effect or magnetoresistance type, or a passive sensor of the eddy current type. More generally, the sensor makes it possible, for example, to provide an output signal with a 0 value when the magnetic field detected is below a reference value and a 1 value when the magnetic field detected is above a reference value.

The measuring system also includes conventional elements for retrieving the output signal, determining the speed of rotation of the rotating component from the output signal (e.g. calculation unit), supplying the value of the speed of rotation to other equipment, powering the sensor if necessary, etc.

With a rotating component according to other embodiments, for example as described with reference to FIG. 2, the sensor can be arranged outside the rotating component and not in a hollow web thereof.

1. A method for manufacturing a rotating component, rotating about an axis, comprising:
a step of producing a formed component from a material in powder form,
a step of obtaining the rotating component from the formed component, wherein the method comprises a step of incorporating a magnetic material into the powder during the production of the formed component, in at least one predefined zone of the formed component, called the magnetized zone, the magnetic material having the following characteristics:
a magnetic remanence (Br) greater than or equal to 0.1 T;
a Curie temperature (T_{c}) greater than or equal to 250° C.;
a hardness of between 75% and 125% of the hardness of the material of the formed component and a density of between 80% and 120% of the density of the material of the formed component.

2. The method for manufacturing according to claim 1, wherein the magnetic material is a samarium-cobalt, Neodymium, or AlNiCo alloy.

3. The method for manufacturing according to claim 1, wherein the magnetic material is incorporated in particles or a pellet form.

4. The method for manufacturing according to claim 1, wherein the magnetized zone is a zone of the component corresponding to an eccentric zone of the axis of the rotating component.

5. The method for manufacturing according to claim 1, wherein the step of producing the rotating component from the powder and the integration of the magnetic material are carried out by additive manufacturing, preferably by sintering or laser melting.

6. The method for manufacturing according to claim 1, wherein the step of obtaining the rotating component comprises a step of machining the formed component and/or a step of assembling it with another component so as to form the rotating component.

7. A rotating component obtained by a method according to claim 1, wherein it comprises at least one integrated magnetized zone.

8. A measuring system for measuring the speed of rotation of a rotating component according to claim 7, wherein it comprises a plurality of sensors arranged in the proximity of the zone of the rotating component comprising the magnetic material and configured so as to each detect a passage of the magnetic zone in front of each sensor in different angular sectors during the rotation of the rotating component.

9. The measuring system according to claim 8, wherein at least one sensor is arranged in a hollow web of the rotating component.

10. The measuring system according to claim 8, wherein the sensors of the plurality of sensors are configured so as to each detect a passage of a plurality of magnetic zones in different angular sectors.

11. The measuring system according to claim 8, wherein at least one sensor is mobile, the position of said sensor being known at any time with respect to the zone of the rotating component comprising the magnetic material.
